(19) United States
(12) Patent Application Publication
(10) Pub. No.: US 2008/0254427 A1
(43) Pub. Date: Oct. 16, 2008

(54) Talking Memory Book

(76) Inventor: Lynn Neviaser, Rixeyville, VA (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/734,106

(22) Filed: Apr. 11, 2007

(51) Int. Cl. G09B 5/06

(52) U.S. Cl. 434/317

(57) ABSTRACT

The talking memory book has front and rear covers, a plurality of pages bound between the covers, and an audio system and audio system control panel, preferably mounted in the rear cover, for recording and playing back a recorded message. The audio system control panel includes electrical switches connected to the control circuit for triggering the audio system to record or play back a message associated with the at least one page. The audio system can also be configured as a digital audio system to accept downloaded audio files.

### BACKGROUND

Various embodiments of the invention are related to books with built-in voice recording devices and more particularly to a personalized talking memory book which can store and playback audio messages corresponding to particular pages in the book.

Talking books are well known and have proven useful for new readers. A book which can provide audio messages corresponding to its pages is advantageous as it can highlight the book's printed material for retention by the reader, provide better comprehension of the printed matter, and contribute to the reader's enjoyment of the book. However, such books generally include a plurality of pre-printed pages and pre-recorded audio messages. The content of these books generally cannot be modified or personalized in any way by the user.

What would be useful is a talking book which can be used to store any desired printed information, including previously-printed matter, and which can record and play back any desired audio message in association with the page. Such an apparatus would be especially advantageous as a personalized recipe book in which one could store grandma's most treasured recipes in written form as well as an audio recording in her voice.

### SUMMARY

An embodiment of the invention comprises a talking memory book that can be personalized by or for the user. The talking memory book comprises a front cover, a rear cover, a plurality of pages bound between the front and rear covers, an audio system, and an audio system control panel associated with the book. Each of the plurality of pages comprises an envelope for holding additional pages and other loose items, such as photographs, recipe cards, post cards, ticket stubs, artwork, notes, locks of hair, etc., about which audio information is desired. The audio system control panel comprises electrical switches that are connected to the audio system. A user may trigger the electrical switches to activate the audio system and enable the audio system to record and/or play voice messages corresponding to a particular page in the book. The audio system can be activated when the book is closed or opened.

An alternative embodiment comprises a talking memory book that includes a front cover, a rear cover, a plurality of pages bound between the covers, and a digital voice recorder for recording and playing back a recorded message. The digital voice recorder comprises a PC data interface such as a universal serial bus (USB). Audio files may be downloaded from a personal computer through the PC data interface and stored in separate files corresponding to one or more pages of the talking memory book.

Another embodiment comprises a system for managing and updating the contents of a talking memory book. The system comprises a talking memory book, a user computer, a cable connecting the user computer with the talking memory book, and an information provider computer. The system also comprises a wide area network (WAN) which provides for data communication between the user computer and the information provider computer. This embodiment allows a user to subscribe to desired information from an information provider and receive the desired audio information on a regular basis for a designated fee together with textual and/or graphical information that may be bound into the book.

Another embodiment comprises a method of updating the contents of a talking memory book. The method comprises subscribing for information with an information provider, receiving information from the information provider in audio and textual and/or graphical format, downloading audio files received from the information provider into the digital voice recorder, and depositing pages of textual and/or graphical information into the book. The subscription allows a user to receive desired information from an information provider on a routine basis.

In one embodiment, a talking memory book is provided that can be personalized by a user to include any desired textual, graphical or audio information.

In another embodiment a talking memory book is provided which is configured to allow a user to record over previously recorded audio information.

In an alternative embodiment a talking memory book is provided which allows a user to input audio information corresponding with particular pages in the book.

In yet another embodiment a talking memory book is provided to which loose pages may be easily added.

These and other embodiments of the invention will become apparent to those skilled in the art from a review of the information that follows.

### BRIEF DESCRIPTION OF THE DRAWINGS

FIG. 1 illustrates an embodiment of a talking memory book in accordance with the present invention when the book is opened.

FIG. 2 illustrates an embodiment of a talking memory book in accordance with the present invention when the book is closed.

FIG. 3 illustrates a talking memory book in accordance with another embodiment of the present invention.

FIG. 4 illustrates a block diagram of a system for managing and updating a talking memory book in accordance with the present invention.

FIG. 5 illustrates a schematic of an exemplary embodiment of an audio system usable with the present invention.

### DETAILED DESCRIPTION

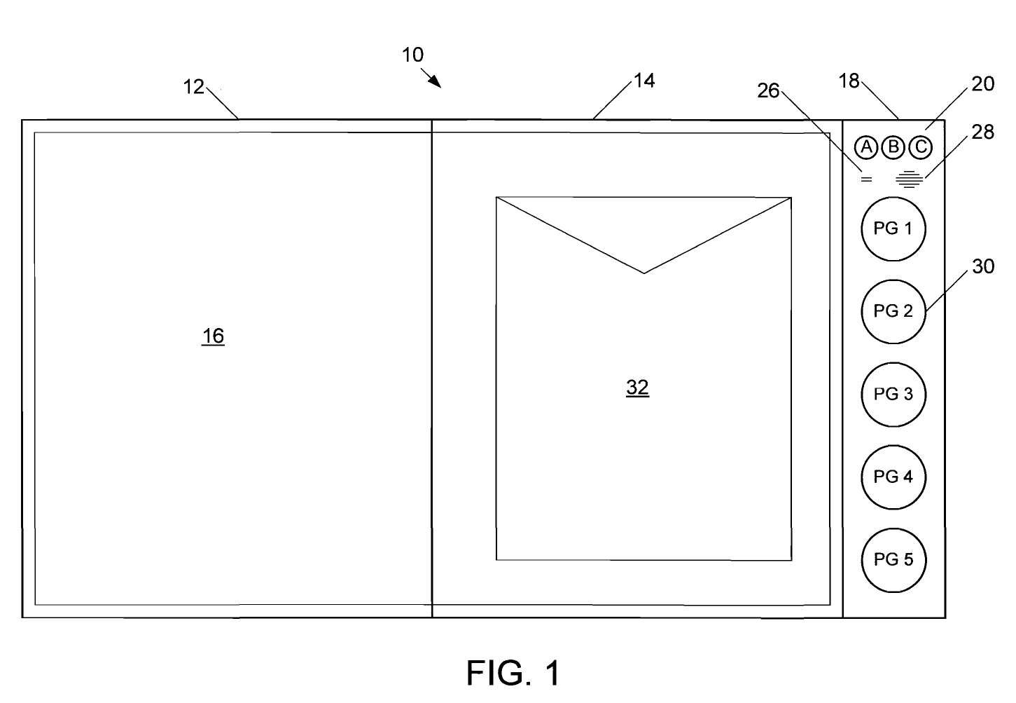

An embodiment of the invention comprises a talking memory book, generally designated as 10 in the drawings. FIG. 1 illustrates one embodiment of the invention wherein the talking memory book 10 is open. Talking memory book 10 allows a reader to view the pages of the book 10 while listening to corresponding recorded audio messages.

As illustrated in FIG. 1, the talking memory book 10 comprises front cover 12 and rear cover 14, a plurality of pages 16 bound between the front and rear covers, 12 and 14, and an audio system 18 and audio system control panel 20 which are mounted in the rear cover 14, although this is not meant as a limitation. The audio system 18 carries out record and play back functions associated with a conventional voice recorder. The audio system 18 can be configured in any suitable manner known in the art. Various patents have disclosed sound systems associated with talking books, including U.S. Pat. No. 6,516,181, issued on Feb. 4, 2003 to Kirwan, which may be relied upon in configuring the sound system of the present invention. While audio system 18 can take various forms, it will typically include a microphone 26 and a speaker 28.

The audio system control panel 20 comprises a plurality of electrical switches 30 that are used to trigger the audio system 18 to record or play messages corresponding to particular pages 16 in the book 10. The control panel 20 can optionally include additional control buttons, such as buttons A, B, and C illustrated herein, to control functions such as recording, appending, erasing, volume, power settings, etc. In one embodiment, as illustrated in FIG. 5, the audio system 18 comprises an electronic control circuit 22, a battery power source 23, a memory device 24, a microphone 26 and a speaker 28.

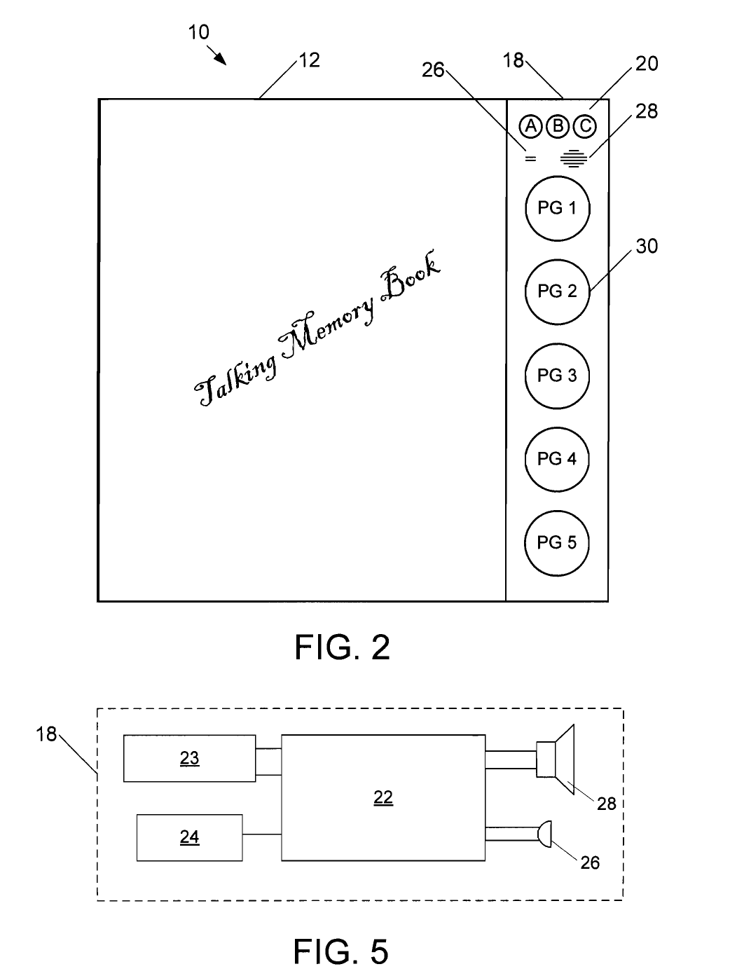

As can be seen in FIG. 2, which shows an embodiment of the talking memory book 10 in a closed configuration, the audio system control panel 20 extends beyond the edge of the front cover 12 and the pages in the book 10. Thus, the audio system 18 can be activated even when the book 10 is closed.

In one embodiment, each of the plurality of pages 16 comprises an envelope 32 attached thereto for holding additional loose pages and other items about which audio information is desired.

The plurality of pages 16 may be permanently or releasably bound to the book 10 in any suitable manner generally known in the art. For example, to allow for removable attachment of the pages 16, the book 10 may be configured as a three-ring binder.

The talking memory book 10 can be personalized by the user to serve a variety of purposes. The talking memory book 10 is particularly useful as a recipe book. A user may cut out recipes from magazines or jot down recipes on loose sheets of paper or recipe cards and store them in the envelope 32 of a particular page in the book. The user may then record a verbal message which corresponds to the recipe stored on that page. Thereafter, the user may not only refer to the written recipe, but also, listen to the corresponding voice message for additional tips while the user is cooking and cannot readily access the written material. Alternatively, the user may simply listen to the recorded message without referring to the written materials in order to be reminded of the desired information. As the electronic switches 30 are accessible by the user even when the talking memory book 10 is closed, the user may listen to the stored audio messages in any desired order without having to turn to particular pages in the book 10.

FIG. 3 depicts an alternative embodiment of the invention, generally designated as 34. Talking memory book 34 comprises a front cover 36, a rear cover 38, a plurality of pages 40 bound between the covers, 36 and 38, and a digital voice recorder 40 mounted in the rear cover 38 for recording and playing back a recorded message. Although the digital voice recorder 40 is illustrated as being mounted in the rear cover, this is not meant as a limitation. In one embodiment, the talking memory book 34 also comprises an envelope 41 on each of the plurality of pages 40.

The digital voice recorder 40 can be any conventional digital voice recorder 40 comprising a PC data interface 42 such as a universal serial bus (USB). Alternative interfaces to USB include, but are not limited to, IrDA, Ethernet, wireless IEEE 802.11b/g/n protocol interfaces, and wireless IEEE 802.15.1 Bluetooth protocol interfaces. In one embodiment, the digital voice recorder 40 further comprises a display screen 44 and at least one switch 46 which extend above the surface of the rear cover 38 and is accessible by the user. The display screen 44 is preferably a touch screen which allows the user to interact with the recorder 40 in a manner similar to that employed in so-called “personal digital assistants.” The switch 46 is used to control conventional functions provided in a conventional voice recorder, such as “record”, “play”, “rewind”, and “stop”. Digital voice recorder 40 also includes a speaker 47 and, preferably, a microphone 45. The talking memory book 34 can record, store, and play back voice as in talking memory book 10. However, unlike the talking memory book 10, audio files from a personal computer (PC) may be downloaded to the digital voice recorder 40 through the PC data interface 42 and stored in separate files corresponding to one or more pages of the talking memory book 34. As illustrated, the portion of the rear cover 38 which houses the digital voice recorder 40 extends beyond the edge of the front cover 36 and the pages 40 in the book 34. Thus, the digital voice recorder 40 is also accessible when the book 34 is closed.

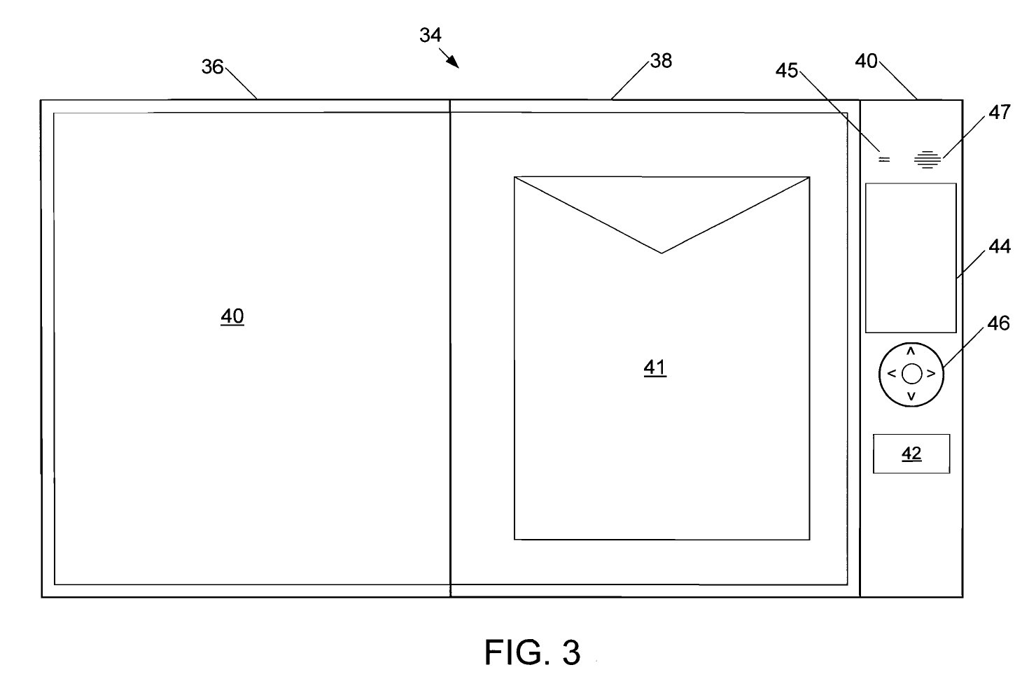

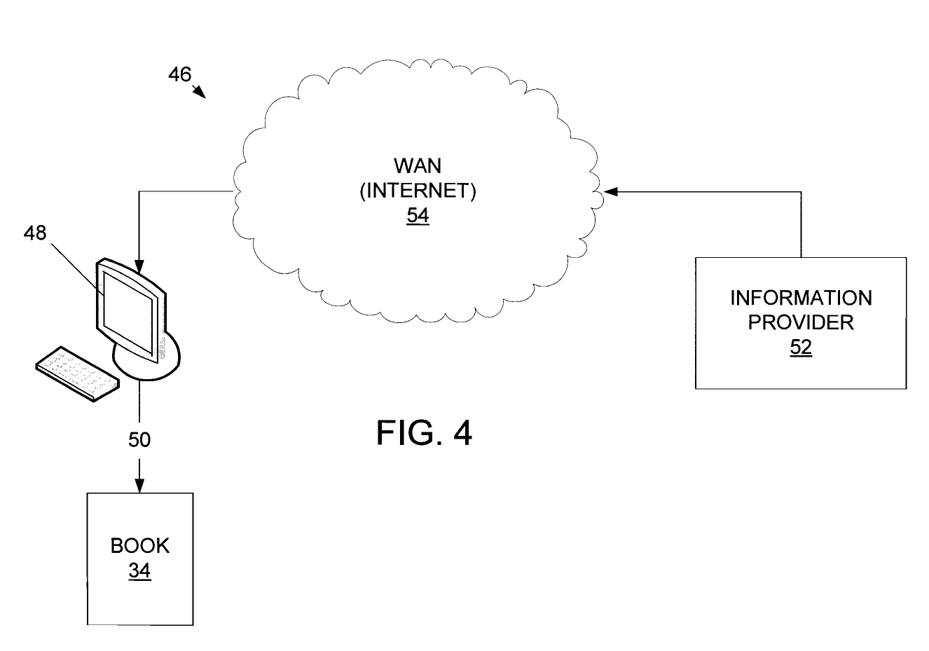

FIG. 4 illustrates yet another embodiment of a method of using the present invention. In FIG. 4, reference numeral 46 generally indicates a system for managing and updating the contents of a talking memory book 34. The system 46 comprises talking memory book 34, a user computer 48, a cable or wireless means 50 connecting the user computer 48 with the talking memory book 34, and an information provider computer 52. Also illustrated in FIG. 4 is a wide area network (WAN) 54, such as the Internet, which provides for data communication between the user computer 48 and the information provider computer 52. In one embodiment, a user may update the contents of talking memory book 34 by subscribing for desired information from an information provider. Such a subscription permits the information provider to provide audio and/or textual and/or graphical information to the user on a regular basis for a designated fee. The information provider would send the desired information to the user over the Internet, for example. The user would then connect the talking memory book 34 to the user computer 48 through the cable or wireless means 50 and, thereby, directly download any audio information sent by the information provider. The user may deposit any printed textual and/or graphical information in the envelope 41 corresponding to a page of the book 34.

The system 46 can be utilized for various purposes. If the talking memory book 34 is a recipe book, for example, the user may enroll for a recipe subscription with a recipe provider. The recipe provider would then routinely email recipes in audio and textual format to the user in accordance with the terms of the subscription. The user may download any desired audio files into the digital voice recorder 40 and insert corresponding printed recipes in the separate envelopes 41. The user can assign each stored audio file a numeric designation corresponding to the page number in which the associated recipe is stored.

In another possible embodiment where the talking book 34 is a story book, the user may enroll for a short story subscription with a provider of short stories. The story provider would then routinely email stories in audio and textual format to the user in accordance with the terms of the subscription. The user may download any desired audio files into the digital voice recorder 40 and attach pages of printed stories to the book 34. In this embodiment, the talking book 34 can be configured to accommodate removable attachment of pages, as described previously. Each additional page incorporated in the talking memory book 34 would be numbered and each audio message stored in the digital voice recorder 40 would be saved under an identifier which includes the page number of the corresponding text.

A talking memory book and a system and method for updating the talking memory book have been described. It will be understood by those skilled in the art that the invention may be embodied in other specific forms without departing from the scope of the invention disclosed and that the examples and embodiments described herein are in all respects illustrative and not restrictive. Those skilled in the art will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A talking memory book comprising:
a front cover;
a rear cover;
a plurality of pages bound between the front and rear covers;
an audio system mounted within the book; and
an audio system control panel mounted within the book comprising electrical switches, the electrical switches being connected to the audio system; whereby the electrical switches activate the audio system to record and playback voice or other audio files corresponding to pages in the book.

2. The talking memory book according to claim 1, wherein the audio system comprises:
an electronic control circuit;
a memory device;
a battery power source;
a microphone; and
a speaker;
wherein said microphone and speaker are connected the electronic control circuit.

3. The talking memory book according to claim 1, wherein the audio system control panel extends beyond the edge of the front cover and the pages of the talking memory book.

4. The talking memory book according to claim 1, wherein the plurality of pages are permanently bound to the talking memory book.

5. The talking memory book according to claim 1, wherein the plurality of pages are releasably bound to the talking memory book.

6. A talking memory book comprising:
a front cover;
a rear cover;
a plurality of pages bound between the front and rear covers; and
a digital voice recorder mounted in the rear cover for recording and playing back a recorded message.

7. The talking memory book according to claim 6, wherein the digital voice recorder comprises a PC data interface to allow for transfer of audio files from a personal computer.

8. The talking memory book according to claim 7, wherein the PC data interface comprises a universal serial bus (USB).

9. The talking memory book according to claim 7, wherein the PC data interface is selected from the group consisting of an infrared data networking interface, Ethernet, IEEE 802.11b, IEEE 802.11g, IEEE 802.11n, and IEEE 801.15.1 interfaces.

10. The talking memory book according to claim 6, wherein the digital voice recorder comprises a display screen and a switch which are located on an extended surface of the rear cover.

11. A system for updating the contents of a talking memory book comprising:
a talking memory book;
a user PC;
a cable connecting the user PC with the talking memory book;
an information provider PC for providing information to the user PC; and
a wide area network (WAN) which provides for data communication between the user PC and the information provider PC;
whereby a user may update the contents of talking memory book by downloading desired information from an information provider.

12. The system according to claim 11, wherein the information provided by the information provider PC is recipes in audio and textual and/or graphical format.

13. The system according to claim 11, wherein the information provided by the information provider is short stories in audio and textual and/or graphical format.

14. A method for updating the contents of a talking memory book comprising:
subscribing for information with an information provider;
receiving information from the information provider in audio and textual and/or graphical format; and
downloading audio files received from the information provider into the digital voice recorder.

15. The method of claim 14, further comprising:
printing textual and/or graphical information provided by the information provider as printed pages; and
inserting the printed pages into the talking memory book.

16. The method of claim 14, further comprising:
printing textual and/or graphical information provided by the information provider; and
inserting the printed information into envelopes provided on the pages of the talking memory book.

17. The talking memory book according to claim 1, wherein the pages further comprise associated envelopes for storing items.

18. The talking memory book according to claim 7, wherein the pages further comprise associated envelopes for storing items.

19. The talking memory book according to claim 7, wherein the PC data interface is a wireless networking interface.
